(19) United States
(12) Patent Application Publication
(10) Pub. No.: US 2026/0277943 A1
(43) Pub. Date: Sep. 17, 2026

(54) SLIDING WINDOW DOCUMENT INDEXING USING GENERATIVE ARTIFICIAL INTELLIGENCE

(71) Applicant: Microsoft Technology Licensing, LLC, REDMOND, WA (US)

(72) Inventor: John Anthony TAYLOR, Bellevue, WA (US)

(21) Appl. No.: 19/079,054

(22) Filed: Mar. 13, 2025

(51) Int. Cl. G06F 16/31; G06F 16/93

(52) U.S. Cl. CPC G06F 16/31; G06F 16/93

(57) ABSTRACT

Methods, apparatuses, and products for indexing pages of a document include generating, for each page window of a plurality of page windows of a document, a description of each page of a respective page window, including: selecting a particular page window of a plurality of page windows of the document by applying a sliding window to a plurality of pages of the document; prompting a generative artificial intelligence (AI) model to generate a description of each page in the particular page window based on any included visual content and contextual information including each other page in the particular page window; and receiving, as output from the generative AI model, the description of each page in the particular page window; and generating index data for the document based on the output from the generative AI model for each page window of the plurality of page windows.

### BACKGROUND

Indexes map portions of index data to portions of a document, allowing various types of applications and systems to quickly search and access the document. These applications and systems may apply search queries to the index to find relevant index data, which then allows the mapped portions of the document to be retrieved. Generative artificial intelligence (AI) can be used to automatically generate indexes for documents. For example, some generative AI models, such as large language models (LLMs), can interpret various types of input, including text and visual content, and provide natural language output based on a prompt to the model. These generative AI models can generate descriptions of different portions of the document, such as each page. Index data is then generated based on these descriptions and mapped back to the portion of the document corresponding to each description.

Generative AI models have limitations on the amount of data they can process in one prompt. For example, a generative AI model may be limited in the number of tokens it can process in one prompt. Accordingly, prompting the generative AI model to create an index for a large document by providing the entire document in a single prompt may be impractical. Instead, in some implementations, the generative AI model is prompted with each page of the document individually and requested to generate a description of the corresponding page.

Although generating descriptions of each page of a document individually allows for indexing documents of any size, generative AI models struggle to accurately or completely describe some pages when their interpretation depends on the content of other pages, especially when a page includes some visual content such as a diagram or other image. For example, one page of a document may include a diagram of a device with numbered part labels while another page maps each numbered label to the name of the part. In this example, the generative AI model may not be able to accurately describe every aspect of the diagram in isolation without the additional context of the other pages.

One or more embodiments are described below that relate to a method, an apparatus, or a product for sliding window document indexing using generative artificial intelligence (AI) are described herein. In some aspects, sliding window document indexing using generative artificial intelligence (AI) includes: generating, for each page window of a plurality of page windows of a document, a description of each page of a respective page window, including: selecting a particular page window of a plurality of page windows of the document by applying a sliding window to a plurality of pages of the document; prompting a generative artificial intelligence (AI) model to generate a description of each page in the particular page window based on any included visual content and contextual information including each other page in the particular page window; and receiving, as output from the generative AI model, the description of each page in the particular page window; and generating index data for the document based on the output from the generative AI model for each page window of the plurality of page windows. In some aspects, an apparatus may include a memory and one or more processing devices, operatively coupled to the memory, the one or more processing devices configured to perform similar steps. In some aspects, a computer program product comprising a computer readable storage medium may store computer program instructions that, when executed, perform similar steps.

### BRIEF DESCRIPTION OF DRAWINGS

FIG. 1 sets forth a diagram of an example system for sliding window document indexing using generative artificial intelligence (AI) in accordance with some embodiments of the present disclosure.

FIG. 2 sets forth example table diagram for processing sliding page windows for sliding window document indexing using generative artificial intelligence (AI) in accordance with some embodiments of the present disclosure.

FIG. 3 sets forth an example flowchart for sliding window document indexing using generative artificial intelligence (AI) in accordance with some embodiments.

FIG. 4 sets forth a flowchart illustrating an example method of sliding window document indexing using generative artificial intelligence (AI) in accordance with some embodiments.

FIG. 5 sets forth a flowchart illustrating an additional example method of sliding window document indexing using generative artificial intelligence (AI) in accordance with some embodiments.

FIG. 6 sets forth a flowchart illustrating an additional example method of sliding window document indexing using generative artificial intelligence (AI) in accordance with some embodiments.

FIG. 7 sets forth a flowchart illustrating an additional example method of sliding window document indexing using generative artificial intelligence (AI) in accordance with some embodiments.

FIG. 8 sets forth a flowchart illustrating an additional example method of sliding window document indexing using generative artificial intelligence (AI) in accordance with some embodiments.

FIG. 9 sets forth a flowchart illustrating an additional example method of sliding window document indexing using generative artificial intelligence (AI) in accordance with some embodiments.

FIG. 10 illustrates an exemplary computing device that may be specifically configured to perform one or more of the processes described in the present disclosure.

FIG. 11 sets forth a block diagram of a cloud service provider service architecture in accordance with some embodiments of the present disclosure.

### DESCRIPTION OF EMBODIMENTS

Generative artificial intelligence (AI) models, or some other entity, can index documents to allow the document's contents to be easily searched or otherwise accessed. Generative AI models, such as large language models (LLMs), can be used to automatically generate indexes for documents by summarizing the content of each page. As generative AI models are capable of processing various types of input, including text and images, these generative AI models can be used to index documents that include visual content such as photographs, diagrams, or other images. To do so, the generative AI model generates a textual description of the visual content which may then be used to index the document.

Generative AI models may have limitations on the amount of data that they can process in one prompt. It may be impossible for a generative AI model to accept an entire document for indexing if the document is too large. Existing approaches for indexing may involve prompting the generative AI model to produce a description of each page individually. This approach may not be suitable where understanding the content of one page depends on adjacent or nearly adjacent pages. For example, one page of a document may include a diagram of a device with numbered part labels while another page maps each numbered label to the name of the part. In this example, the generative AI model may not be able to accurately describe every aspect of the diagram when generating a description of that page in isolation without the additional context of the other pages.

To improve the performance of generative AI models, the approaches set forth herein provide a system for indexing a document using a sliding window. A window of pages is selected from a document using a sliding window. A generative AI model is prompted to generate descriptions for each page in a window. The prompt indicates that the generative AI model may use the other pages in a window when generating a description for a given page. This process repeats for all the page windows of the document. This will result in multiple descriptions for each page, one description for each window that includes a given page. A description for a given page is selected from these multiple descriptions using the generative AI model. The selected description for each page is then used to generate indexing data for that page of the document.

Document indexing is essential in any field or product that uses a searchable knowledge base. The approaches set forth herein provide approaches for automatic indexing of documents using sliding windows and generative AI. The sliding window approach allows for the description, and resulting index, for a given page to be generated based on adjacent or nearly adjacent pages. This improves the contextual knowledge available to the generative AI model when generating these descriptions, improving overall accuracy and quality of the resulting index. More accurate indexing will result in higher quality end products, improving customer engagement and overall revenue.

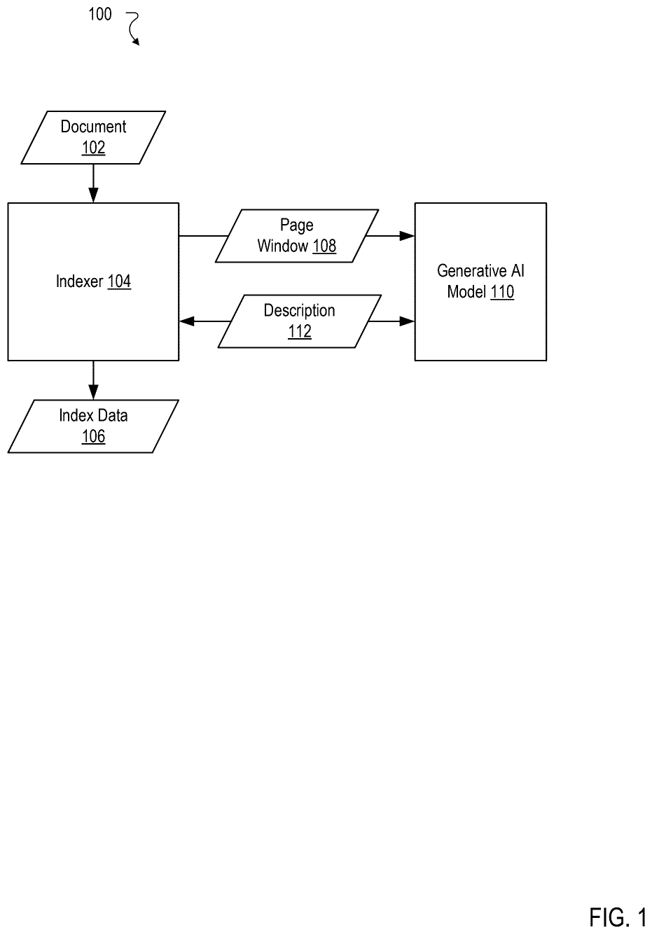

FIG. 1 sets forth an example system 100 for sliding window document indexing using generative AI in accordance with some embodiments of the present disclosure. To begin, a document 102 is provided to an indexer 104 to generate index data 106 for the document 102.

The indexer 104 may be embodied, for example, as a system, software application, or other mechanism that is responsible for creating, updating, and maintaining an index. A document 102 is data encoding some amount of text and/or visual content. In this example, the document 102 includes visual content such as one or more images. Readers will appreciate that, in one or more embodiments, the indexer 104 or other entity may apply the approaches set forth herein to documents that do not include visual content. The document 102 may include any file format for documents 102 as would be appreciated by one skilled in the art. For example, in one or more embodiments, the document 102 may include a Word document 102, a Portable Document Format (PDF) document 102, or another document 102 format as can be appreciated. In one or more embodiments, the document 102 may be encoded as a set of images. For example, in one or more embodiments, the document 102 may be encoded as a set of images each corresponding to a different page of the document 102. In one or more embodiments, the document 102 may include a read-only document 102 or an editable document 102.

Index data 106 is data that may be referenced or accessed with a search query to identify portions of the document 102 responsive to the search query. The index data 106 may be used, for example, in conjunction with other index data 106 as an index for a knowledge base of content that includes the document 102. The particular encoding format of the index data 106 may depend on the specific search approaches supported by the index data 106 and potentially other design or engineering considerations.

To generate the index data 106, the indexer 104 repeatedly selects sets of pages from the document 102. Although at least one embodiment applies the approaches described herein to pages of a document 102, at least one other embodiment can apply the approaches described herein to other subdivisions, subsections, or component parts of a document 102. Particularly, the indexer 104 selects sets of pages from the document 102 using a sliding window approach.

Accordingly, these selected sets of pages are shown as page windows 108. Using a sliding window approach, a fixed number of consecutive pages are selected from the document. After selecting and processing a page window 108 as described below, the next page window 108 is selected to include the page sequentially after the previous page window 108 and to exclude the sequentially first page of the previous page window 108. The size of the page window 108 may include any value of two or more as can be appreciated, with the particular size of the page window 108 being determined based on various design or engineering considerations. In one or more embodiments, the size of the page window 108 may include a fixed or predefined value. In one or more embodiments, the size of the page window 108 may include a configurable or tunable value.

Having selected a page window 108, the indexer 104 provides the page window 108 to a generative artificial intelligence (AI) model 110 to generate a description 112 for each page in the page window 108. Generative AI models, including LLMs and multimodal large language models (MLMMs), may generate content such as text, code, graphics, animations, video, audiovisual representations, audio, speech, etc., in response to prompts. The generative AI models 110 are trained using a corpus of training data content to learn the patterns and structure of that content. The generative AI model 110 may then generate new content having the characteristics learned from the training data. Prompts may include text, code, audio, graphic, video, and representations in any other media. Such prompts may be provided to the generative AI model as a natural language input. For example, the approaches set forth herein may interact with a generative AI model using predefined prompts, dynamically generated prompts, prompts that include some portion of dynamically generated content (e.g., through the use of templates and dynamically populated variables), and the like.

Here, the generative AI model 110 is a model capable of processing some input, including text, visual content, and potentially inputs of other modalities, to produce natural language expression(s) as output. For example, in one or more embodiments, the generative AI model 110 may include a language model such as a large language model (LLM), a small language model (SLM), or any other generative AI model 110 capable of understanding and producing natural language expressions. In one or more embodiments, the generative AI model 110 includes a locally implemented generative AI model 110. For example, the generative AI model 110 may be implemented in the same physical system as the indexer 104, or in a different physical system sharing a local network with the indexer 104. In one or more embodiments, the generative AI model 110 may include a remotely disposed or remotely implemented generative AI model 110. For example, in one or more embodiments, the generative AI model 110 may be implemented in a cloud computing environment or other computing environment remotely disposed relative to the indexer 104. In one or more embodiments, the generative AI model 110 may include a specifically trained or fine-tuned model that has been trained or tuned using some corpus of training data to perform the various operations described herein. In one or more embodiments, the generative AI model 110 may include a non-specifically trained or off-the-shelf generative AI model that has not been specifically tuned or trained to perform these operations.

In one or more embodiments, the indexer 104 provides the page window 108 to the generative AI model 110 as part of a prompt that instructs the generative AI model 110 to generate a description 112 for each page in the page window 108. In one or more embodiments, the indexer 104 may prompt the generative AI model 110 using an application programming interface (API) or other interface for prompting and receiving output from the generative AI model 110. The description 112 of a page is a natural language summary of the contents of that page as interpreted by the generative AI model 110. For example, where a page includes text information, the description 112 may include a summary of the text or another description 112 of the contents of the text. As another example, where a page includes some visual content, the description 112 may include a description 112 of what is depicted in the visual content. These descriptions 112 may leverage the capability of generative AI models 110, including language models, to interpret inputs across various modalities, including text and visual content, to produce natural language descriptions 112.

In some existing implementations, a generative AI model 110 may generate a description 112 of a page of a document 102 in isolation. In other words, in some implementations, the generative AI model 110 may generate a description 112 of a page based on the contents of that page, independent of any other page of the document 102. Although this may be adequate for some pages, other pages may benefit from additional context provided by other portions of the document 102. For example, assume a first page with an image of a camera with various parts of the camera identified by a number. Further assume that a second page includes a key that maps these part numbers to the names of the corresponding parts. In isolation, a generative AI model 110 may be able to determine that the first page includes a camera and may be able to identify some of the numbered parts. However, the generative AI model 110 may have to guess the names of some of the other parts. This may result in a description 112 that includes inaccurate information or lacks some information. In one or more embodiments, the generative AI model 110 may have a limit as to how much input information can be processed in one prompt.

Accordingly, in one or more embodiments, it may be impossible to provide an entire document 102 to the generative AI model 110 to use other pages when generating the description 112 of a particular page.

In contrast, the approaches set forth herein use the generative AI model 110 to generate descriptions 112 in a page window 108 using each other page in the page window 108 as contextual information. Contextual information is data outside of the page being described by the description 112 that may be used by the generative AI model 110 in generating the description 112. Such contextual information may or may not be ultimately used by the generative AI model 110 when generating a description 112 for a particular page (e.g., the description 112 may or may not be affected by the contextual information). In other words, the generative AI model 110 may use other pages in a page window 108 when generating a description 112 for the particular page. Returning to the example above, when generating a description 112 for the first page including the image of the camera, the generative AI model 110 may use the second page including the key as contextual information. This allows the generative AI model 110 to use the key of the second page to identify the numbered parts of the camera from the first page, improving the overall accuracy and quality of the description 112.

In one or more embodiments, the generative AI model 110 may receive a prompt indicating that a description 112 should be generated for each page that may take into account other pages in the page window 108. For example, a prompt to the generative AI model 110 may indicate “Describe each page separately, provide as much details as you can but base your description only on what you see in the page, do not guess. You can use the content of other pages to enrich your description appropriately.” This prompt is merely illustrative, and other prompts are contemplated within the scope of the present disclosure. Moreover, readers will appreciate that the particular structure and content of the prompt may depend on the particular generative AI model 110 used. In one or more embodiments, the prompt to the generative AI model 110 may request descriptions 112 for all pages in a page window 108. In one or more embodiments, the prompt to the generative AI model 110 may request a description of a specific page in a page window 108. In such embodiment, to generate descriptions 112 for each page in a page window 108, the generative AI model 110 may be prompted multiple times, once for each page in the page window.

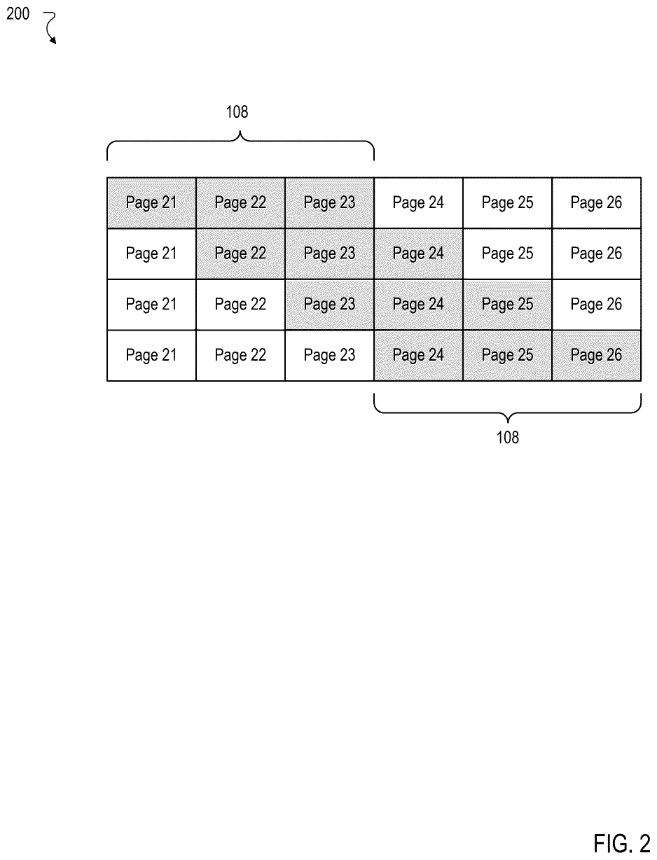

Turning to FIG. 2, shown is an example table diagram 200 for processing sliding page windows 108 for sliding window document indexing using generative AI in accordance with some embodiments of the present disclosure. Each column of the table diagram 200 corresponds to a different page of a document 102. Each row of the table diagram 200 corresponds to a different sliding window iteration for selecting page windows 108. Each page window 108 includes three pages and is identified by cells highlighted in grey. The first page window 108 includes pages twenty-one, twenty-two, and twenty-three. Given this first page window 108, the generative AI model 110 will generate a description of page twenty-one based on the contents of page twenty-one, with pages twenty-two and twenty-three usable as contextual information for the description of page twenty-one. The generative AI model 110 also generates a description 112 of page twenty-two using pages twenty-one and twenty-three as contextual information, and generates a description 112 of page twenty-three using pages twenty-one and twenty-two as contextual information. This process then repeats, adding the next page to the page window 108 and removing the first page from the page window 108.

Turning back to FIG. 1, after processing each page window 108 of the document 102, the indexer 104 has descriptions 112 produced by the generative AI model 110 for each page of the document 102. Since the indexer 104 uses a sliding window approach for generating page descriptions 112, a given page may be included in multiple page windows 108 provided to the generative AI model 110. For example, for a page window 108 size of N, a given page may be included in up to N page windows 108, thereby resulting in up to N descriptions 112 being produced for the given page.

Accordingly, in one or more embodiments, the indexer 104 may select, for each page with multiple descriptions 112, a particular description 112 to use in generating index data 106 for that page. In one or more embodiments, this may include prompting the generative AI model 110, or some other generative AI model 110, with the multiple descriptions 112 for a given page and request that the generative AI model 110 select a description 112 based on some criteria, such as the description 112 most useful for use in search indexing. In one or more embodiments, a particular description 112 may be selected for a page from multiple descriptions 112 according to other approaches as can be appreciated.

The indexer 104 then generates index data 106 for the document 102 by generating, for each page of the document 102, a portion of index data 106 based on its selected description 112 as generated by the generative AI model 110. As mentioned above, the format and encoding of the index data 106 may depend on the specific system and searches used to search the document 102. For example, in one or more embodiments, the index data 106 may include vector index data 106 whereby the description 112 of each page is converted into a vector embedding mapped to the corresponding page. In one or more embodiments, this may include providing each description 112 to an encoder that outputs the corresponding vector embedding. In one or more embodiments, this encoder may include an encoder of the generative AI model 110 or an encoder of another model that may search the document 102 or a knowledge base that includes the document 102.

The approaches set forth above allow for the description 112, and by extension the index data 106, of a given page to be generated based on adjacent or nearly adjacent pages using a sliding window of page windows 108. In one or more embodiments, some portions of a document 102 may be contextually relevant to other portions of the document 102 that are not adjacent or nearly adjacent. For example, a glossary of terms found at the beginning or end of a document 102 may be useful in interpreting pages throughout the document 102. As another example, some documents 102 may include a section specifically identified as to be read first.

Accordingly, in at least one embodiment, the indexer 104 and/or the generative AI model 110 may identify one or more contextually relevant pages of the document 102 and include them in as input to the generative AI model 110 to generate descriptions 112 for a page window 108. This allows the generative AI model 110 to consider these contextually relevant pages, in addition to the other pages in the same page window 108, when generating the description 112 of a particular page. These one or more contextually relevant pages may be identified according to various approaches.

In at least one embodiment, the indexer 104, the generative AI model 110, or some other entity may identify one or more contextually relevant pages based on a user selection of the one or more contextually relevant pages. For example, in one or more embodiments, the indexer 104 may receive, from a user, one or more contextually relevant pages. In one or more embodiments, the indexer 104 may also receive a user-provided description 112 of the one or more contextually relevant pages which may be included in a prompt to the generative AI model 110, thereby providing the generative AI model 110 with additional context as to the nature of the one or more contextually relevant pages.

In one or more embodiments, the indexer 104, the generative AI model 110, or some other entity may identify one or more contextually relevant based on descriptions 112 of pages of the document 102 generated by the generative AI model 110. For example, in one or more embodiments, assume that descriptions 112 of each page of a document 102 are generated and selected as described above. In one or more embodiments, the indexer 104 may prompt the generative AI model 110 with these descriptions 112 to identify any contextually relevant pages. In such embodiments, the indexer 104 may receive, from the generative AI model 110, an indication of any identified contextually relevant pages. In one or more embodiments, when prompting the generative AI model 110 to generate the descriptions 112 for pages in a page window 108, the indexer 104 may include, in the prompt, a request that the generative AI model 110 include, in its output, an indication of any identified contextually relevant pages. In one or more embodiments, the particular criteria used by the generative AI model 110 to identify a contextually relevant page may be included in the prompt requesting their identification.

If the indexer 104 receives an indication of a contextually relevant page, the indexer 104 may prompt the generative AI model 110 to regenerate the descriptions 112 for the pages of the document 102 using similar approaches as are described above, with the identified contextually relevant pages being included in the prompt to the generative AI model 110 along with each page window 108. In one or more embodiments, the generative AI model 110 may need to generate descriptions 112 for each page of a document 102 multiple times: once to generate an initial set of descriptions 112 that may be used to identify contextually relevant pages and a second time if any contextually relevant pages are identified.

In one or more embodiments, the indexer 104, generative AI model 110, or some other entity identifies one or more contextually relevant pages using a listing of sections of the document 102. A listing of sections of the document 102 may include a listing of headers, titles, and the like for each section and a corresponding page for that section. In one or more embodiments, the listing of sections may be extracted from the document 102 itself. For example, a set of pages of the document 102 encoding the listing of sections, such as a table of contents, may be selected from the document 102 using various approaches. Such approaches may include, for example, a user selection, parsing the document for particular keywords or formatting, accessing metadata of the document 102 indicating different sections, and the like. In one or more embodiments, the listing of sections may be dynamically generated from the document 102 by applying text parsing or other algorithms to detect section headings or titles in the document.

In one or more embodiments, the generative AI model 110 may receive the listing of sections of the document 102 in a prompt and identify, using the listing of sections, any contextually relevant pages. In one or more embodiments, the listing of sections may be used by the indexer 104 to identify the contextually relevant pages. For example, pages with particular titles or headers matching certain keywords may be designated as contextually relevant pages.

These identified pages may then be included as contextual information of prompts to the generative AI model 110 to generate descriptions 112 as described above.

The generated index data 106 may then be used in a variety of use cases whereby pages of the document 102 are searched. For example, in one or more embodiments, a user-provided search query may be used to search a knowledge base including the document 102, with any pages of the document 102 responsive to the search query being returned in response. As another example, in one or more embodiments, the document 102 may be included in a knowledge base accessible to a generative AI model 110 through retrieval augmented generation (RAG). The generative AI model 110 may search the knowledge base based on a received prompt. Data responsive to that prompt, including any pages of the document 102, may then be provided to the generative AI model 110 as contextual information for processing the prompt. These use cases are merely illustrative, and other use cases using index-based searches are also contemplated within the scope of the present disclosure.

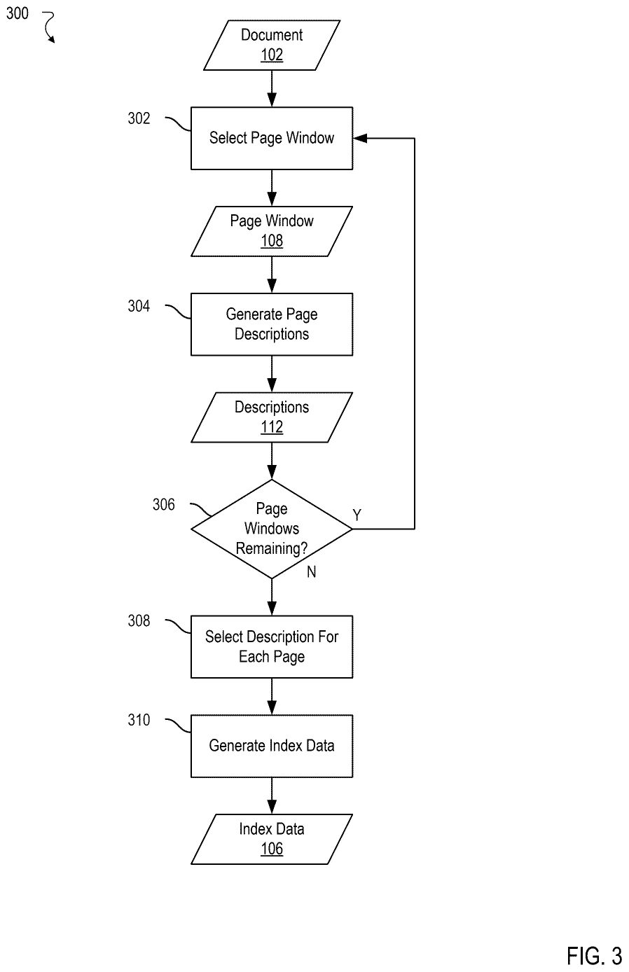

Turning next to FIG. 3, shown is an example flowchart 300 for sliding window document indexing using generative AI in accordance with some embodiments of the present disclosure.

Beginning at step 302, a page window 108 is selected from a document 102. On the first iteration of this flowchart 300, the selected page window 108 is the first page window 108 of a sliding window applied to pages of the document 102. The selected page window 108 includes a fixed number of pages of the document 102.

Next, at step 304, an indexer, a generative AI model, or some other entity can generate descriptions 112 of each page in the page window 108. In one or more embodiments, the generative AI model 110 may receive the page window 108 as part of a prompt requesting that the generative AI model 110 generate descriptions 112 for each page in the page window 108. In one or more embodiments, this prompt may indicate that the generative AI model 110 can use other pages in a page window 108 to inform the description 112 of a given page.

At step 306, an indexer, a generative AI model, or some other entity can determine whether there are any page windows 108 in the document 102 yet to be selected. If not, the process returns to step 302 where the indexer, generative AI model, or some other entity selects the next page window 108. If there are no additional page windows in the document 102 that have yet to be selected, however, the process advances to step 308. In step 308, an indexer, a generative AI model, or some other entity can select a description 112 for each page of the document 102. Each page, except the first and last page of the document 102, may be included in multiple page windows 108. Accordingly, an indexer, a generative AI model, or some other entity may have generated multiple descriptions 112 for these pages. An indexer, a generative AI model, or some other entity may select a description 112 for each page to serve as a basis for the indexing data for that page. For example, in one or more embodiments, the generative AI model may be prompted with the multiple descriptions 112 for a given page and may select the description 112 most useful for search indexing.

After selecting a description for each page, the process advances to step 310 where index data 106 is generated using the selected descriptions 112 for each page. In other words, the description 112 for each page is encoded or converted into a portion of index data 106 that can be mapped back to the corresponding page.

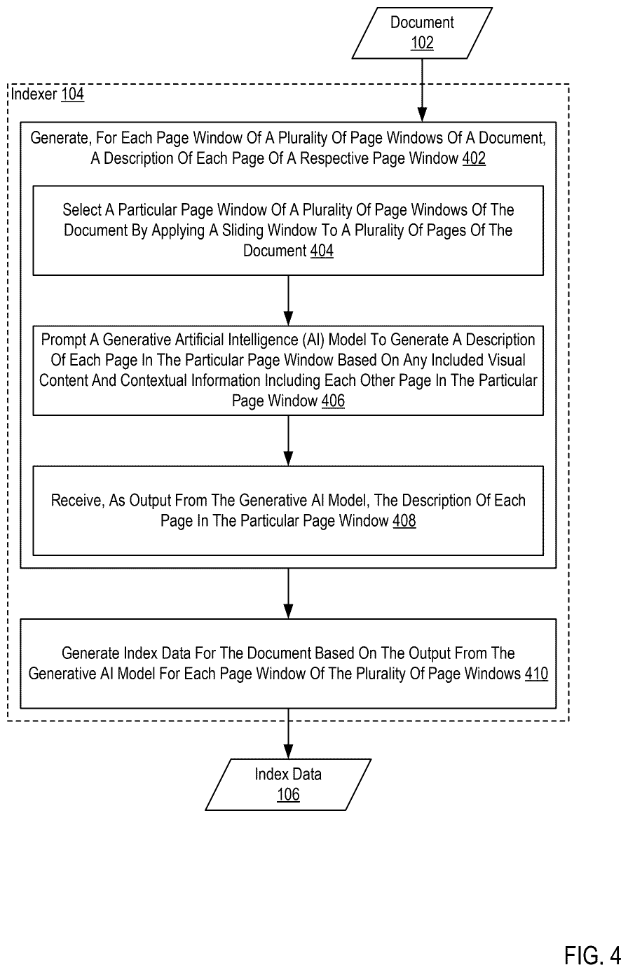

For further explanation, FIG. 4 sets forth a flowchart of an example method of sliding window document indexing using generative AI in accordance with some embodiments of the present disclosure. The method of FIG. 4 may be performed, for example, by an indexer 104 of FIG. 1. The method of FIG. 4 includes generating 402, for each page window 108 of a plurality of page windows 108 of a document 102, a description 112 of each page of a respective page window 108. In other words, a description 112 is generated for each page in each page window 108 of a document 102. The document 102 may include data encoding text and/or visual content such as images. The document 102 may be encoded according to a variety of approaches and using a variety of formats, including Word documents, PDF files, sets of images, or other formats as can be appreciated.

In one or more embodiments, generating 402, for each page window 108 of a plurality of page windows 108 of a document 102, a description 112 of each page of a respective page window 108 includes repeatedly selecting a different page window 108 from the document 102 and generating descriptions 112 for the pages in the selected page window 108. Accordingly, in one or more embodiments, generating 402 a description 112 of each page of a respective page window 108 includes selecting 404 a particular page window 108 of a plurality of page windows 108 of the document 102 by applying a sliding window to a plurality of pages of the document.

A page window 108 is set of consecutive pages of the document 102 having a fixed number of pages. A page window 108 is selected by applying a sliding window in that, assuming N pages in the page window 108, the first N pages of the document 102 are selected for the first page window 108. As each page window 108 is selected, the earliest page in the last page window 108 is removed and the next page after the last page window 108 is added. This process then repeats until the last page window 108 including the last N pages of the document is selected.

Generating 402, for each page window 108 of a plurality of page windows 108 of a document 102, a description 112 of each page of a respective page window 108 also includes prompting 406 a generative artificial intelligence (AI) model 110 to generate a description of each page in the particular page window 108 based on any included visual content and contextual information including each other page in the particular page window 108. After selecting 404 a particular page window 108, the generative AI model may receive the selected page window 108 as input requesting that the generative AI model 110 generate individual descriptions 112 for each page in the selected page window 108. Where a page includes some visual content, the description 112 of the page may include a description 112 of the visual content, thereby leveraging the ability of generative AI models to interpret both text and non-text modalities such as images.

In one or more embodiments, the prompt to the generative AI model 110 indicates that, for a given page, each other page in the page window 108 may be used as contextual information for the description 112 of the given page. These other pages serve as contextual information, providing additional input to the generative AI model 110 that may inform the generative AI model 110 in generating the description 112 for the given page. Thus, the description 112 of the given page may be informed or otherwise affected by information in adjacent or nearly adjacent pages in the same page window 108.

Generating 402, for each page window 108 of a plurality of page windows 108 of a document 102, a description 112 of each page of a respective page window 108 also includes receiving 408, as output from the generative AI model 110, the description 112 of each page in the particular page window 108. The indexer 104, generative AI model 110, or some other entity may repeatedly perform that steps of selecting 404 a particular page window 108, prompting 406 the generative AI model to generate a description 112 of each page in the particular page window 108, and receiving 408 the description 112 of each page as output from the generative AI model 110 for all page windows 108 of the document 102 (e.g., until the last page window 108 of the applied sliding window).

The method of FIG. 4 also includes generating 410 index data for the document 102 based on the output from the generative AI model 110 for each page window 108 of the plurality of page windows 108. In other words, the generative AI model 110 can use the descriptions 112 generated by prompting 406 the generative AI model 110 with each page window 108 to generate index data 106 for the document 102. In one or more embodiments, a description 112 of a given page is encoded or otherwise transformed into a portion of index data 106 that may be mapped to the given page. Thus, a search query applied to the index data 106 may return pages of the document 102 whose index data 106 is responsive to the search query. Readers will appreciate that the particular approaches for generating 410 the index data and the particular encoding and format of the index data 106 may vary depending on the type of index data 106 being generated, the particular types of search to be supported by the index data 106, or other criteria as can be appreciated. For example, in one or more embodiments, generating the index data 106 may include generating a vector embedding of a description 112 for each page, with each vector embedding serving as index data 106 mapped back to the corresponding page. In one or more embodiments, this may include providing a description 112 to an encoder, such as an encoder of a generative AI model 110 that may query or access the index data 106 to search the document 102.

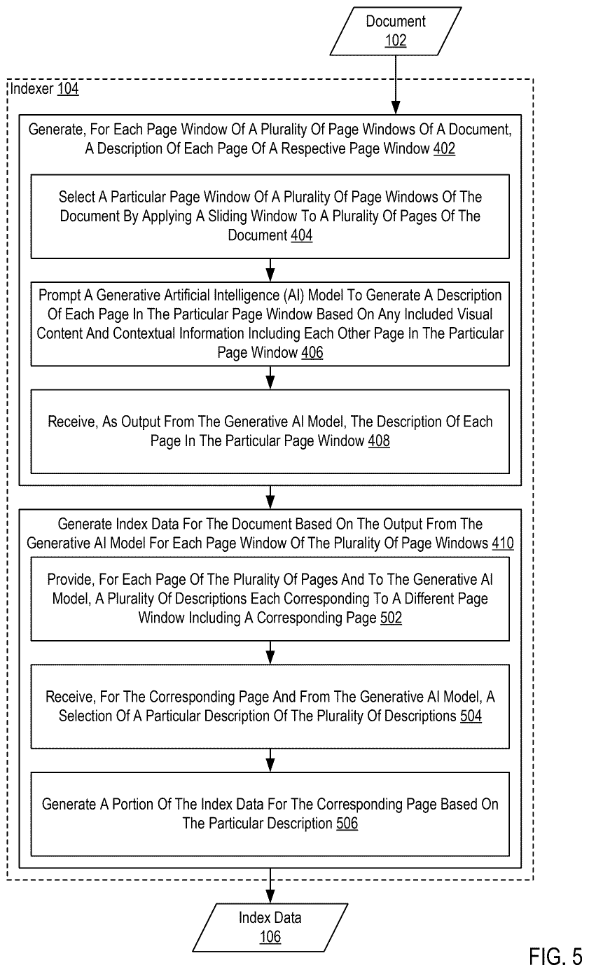

For further explanation, FIG. 5 sets forth a flowchart of another example method of sliding window document indexing using generative AI in accordance with some embodiments of the present disclosure. The method of FIG. 5 is similar to FIG. 4, differing in that generating 410 the index data 106 for the document 102 also includes providing 502, for each page of the plurality of pages and to the generative AI model 110, a plurality of descriptions 112 each corresponding to a different page window 108 including a corresponding page. As the page windows 108 are selected 404 using a sliding window approach, pages of the document 102 (e.g., other than the first and last page) will be included in multiple page windows 108. Accordingly, each of these pages will have multiple descriptions 112 generated by the generative AI model 110.

To determine which of these multiple descriptions 112 will be used for the index data 106 of the corresponding page, the generative AI model 110 may receive these multiple descriptions 112 as part of a prompt (or some other input) requesting that the generative AI model 110 select one of the descriptions 112 for use. In one or more embodiments, this prompt may indicate the criteria that the generative AI model 110 should use in selecting a description 112. For example, in one or more embodiments, the prompt may request that the generative AI model 110 select a description 112 most useful for search indexing. In one or more embodiments, other criteria for selecting a description 112. may be provided to the generative AI model 110.

Generating 410 the index data 106 for the document 102 also includes receive 504, for the corresponding page and from the generative AI model 110, a selection of a particular description 112 of the plurality of descriptions 112. After being prompted with the multiple descriptions 112 for a page, the generative AI model 110 outputs a selected description 112 to be used in the index data 106 for that page. In one or more embodiments, this output may include the selected description 112 itself or an identifier for the selected description 112.

Generating 410 the index data 106 for the document 102 also includes generating 506 a portion of the index data 106 for the corresponding page based on the particular description 112. Thus, the indexer 104, generative AI model 110, or some other entity generates index data 106 for a page using the description 112 selected by the generative AI model 110 from the multiple descriptions 112 for that page. In one or more embodiments, the steps of providing 502 the plurality of descriptions 112, receiving 504 a selection of a particular description 112 and generating 506 the portion of the index data based on the particular description 112 may be repeatedly performed for each page for which multiple descriptions 112 were generated.

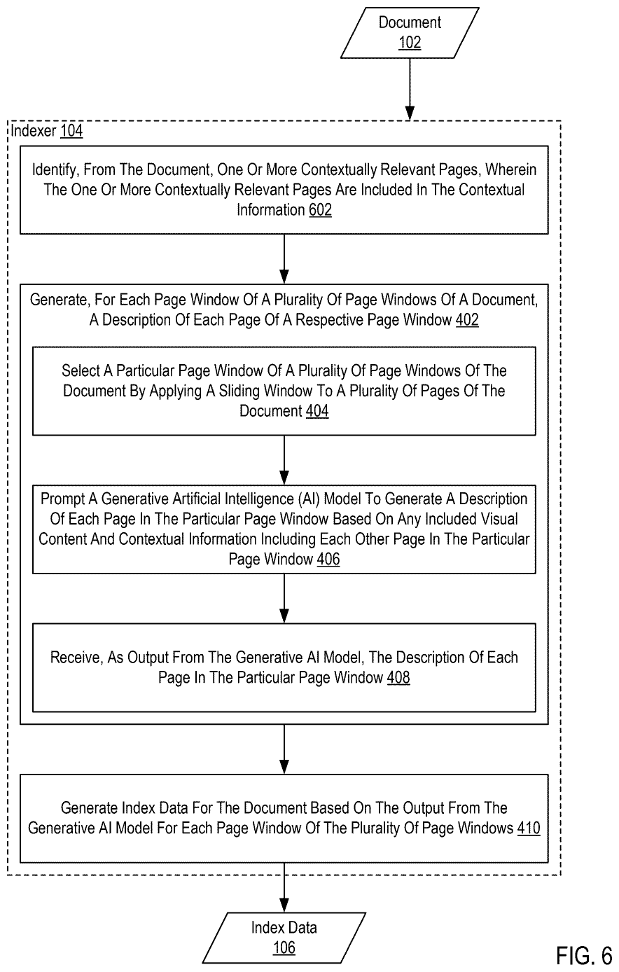

For further explanation, FIG. 6 sets forth a flowchart of another example method of sliding window document indexing using generative AI in accordance with some embodiments of the present disclosure. The method of FIG. 6 is similar to FIG. 4, differing in that the method of FIG. 6 also includes identifying 602, from the document 102, one or more contextually relevant pages, wherein the one or more contextually relevant pages are included in the contextual information. In one or more embodiments, some portions of a document 102 may be contextually relevant to other portions of a document 102 that are not adjacent or nearly adjacent. For example, a glossary of terms found at the beginning or end of a document 102 may be useful in interpreting pages throughout the document 102. As another example, some documents 102 may include a section specifically identified as to be read first.

Accordingly, in one or more embodiments, one or more contextually relevant pages of the document 102 may be identified 602 and included in the contextual information provided to the generative AI model 110 when prompting 406 to generate the descriptions 112. This allows the generative AI model 110 to consider these contextually relevant pages, in addition to the other pages in the same page window 108, when generating the description 112 of a particular page.

The one or more contextually relevant pages may be identified 602 using various approaches, described in further detail below in subsequent flowcharts.

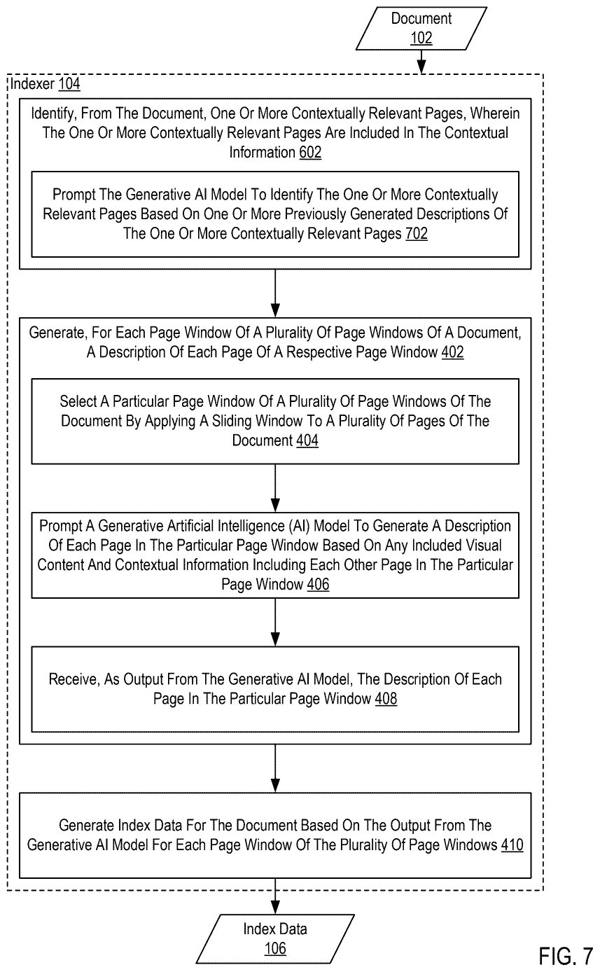

For further explanation, FIG. 7 sets forth a flowchart of another example method of sliding window document indexing using generative AI in accordance with some embodiments of the present disclosure. The method of FIG. 7 is similar to FIG. 4, differing in that identifying 602, from the document 102, one or more contextually relevant pages includes prompting 702 the generative AI model 110 to identify the one or more contextually relevant pages based on one or more previously generated descriptions 112 of the one or more contextually relevant pages. In one or more embodiments, after generating 402 descriptions 112 as described above, the indexer 104 may prompt 702 the generative AI model 110 to identify any contextually relevant pages from the document 102 based on these descriptions 112. In one or more embodiments, the particular criteria used by the generative AI model 110 to identify a contextually relevant page may be included in the prompt requesting their identification. The indexer 104 may then receive, as output from the generative AI model 110, an indication of any identified contextually relevant pages.

If the indexer 104 receives an indication of a contextually relevant page, the indexer 104 may again generate 402 the descriptions 112 for the pages of the document 102 using similar approaches as are described above, with the identified contextually relevant pages being included in the prompts to the generative AI model 110 along with each page window 108. In one or more embodiments, the generative AI model 110 may need to generate descriptions 112 for each page of a document 102 multiple times: once to generate an initial set of descriptions 112 that may be used to identify contextually relevant pages and a second time if any contextually relevant pages are identified.

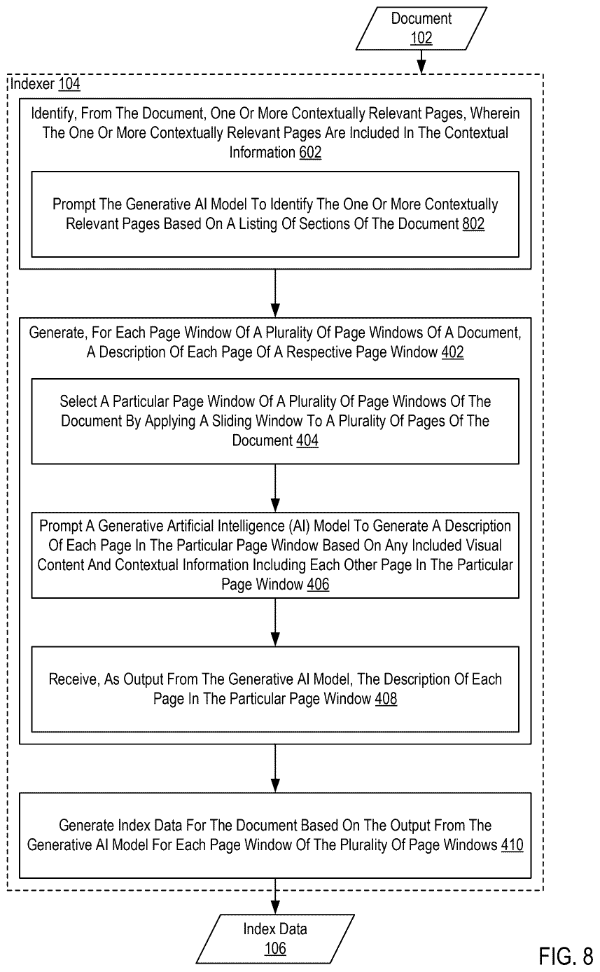

For further explanation, FIG. 8 sets forth a flowchart of another example method of sliding window document indexing using generative AI in accordance with some embodiments of the present disclosure. The method of FIG. 8 is similar to FIG. 4, differing in that identifying 602, from the document 102, one or more contextually relevant pages includes prompting 802 the generative AI model 110 to identify the one or more contextually relevant pages based on a listing of sections of the document 102. A listing of sections of the document 102 may include a listing of headers, titles, and the like for each section and a corresponding page for that section.

In one or more embodiments, the listing of sections may be extracted from the document 102 itself. For example, a set of pages of the document 102 encoding the listing of sections, such as a table of contents, may be selected from the document 102 using various approaches. Such approaches may include, for example, a user selection, parsing the document for particular keywords or formatting, accessing metadata of the document 102 indicating different sections, and the like. In one or more embodiments, the listing of sections may be dynamically generated from the document 102 by applying text parsing or other algorithms to detect section headings or titles in the document. In one or more embodiments, the generative AI model 110 may receive the listing of sections of the document in a prompt and subsequently identify, using the listing of sections, any contextually relevant pages. These identified pages may then be included as contextual information of prompts to the generative AI model 110 to generate descriptions 112 as described above.

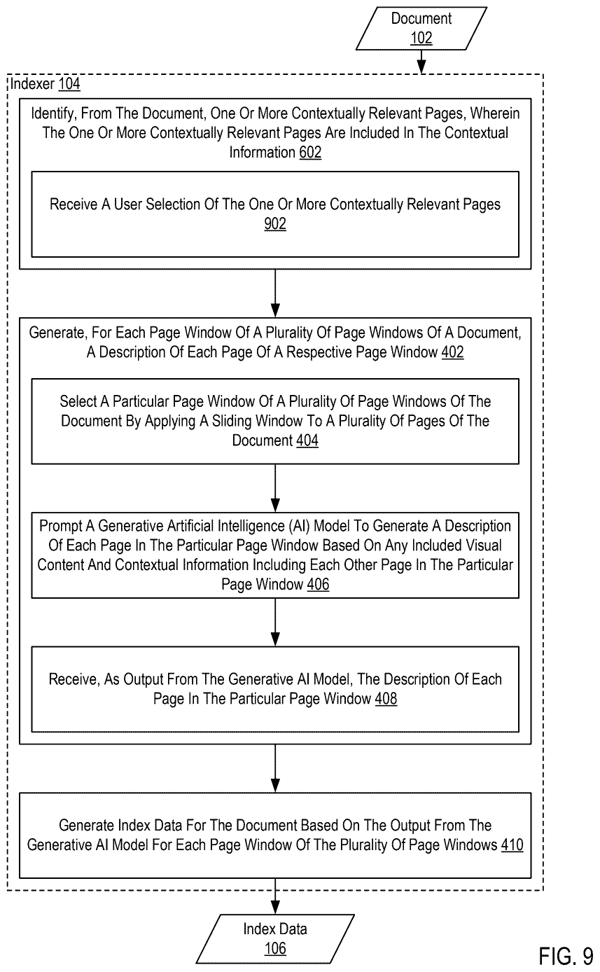

For further explanation, FIG. 9 sets forth a flowchart of another example method of sliding window document indexing using generative AI in accordance with some embodiments of the present disclosure. The method of FIG. 9 is similar to FIG. 4, differing in that identifying 602, from the document 102, one or more contextually relevant pages includes receiving 902 a user selection of the one or more contextually relevant pages. For example, in one or more embodiments, the indexer 104 may receive, from a user, data indicating one or more contextually relevant pages. As another example, in one or more embodiments, the document 102 may include user-provided annotations or tags indicating contextually relevant pages. The indexer 104 may access or extract these identified contextually relevant pages and include them as contextual information for prompts to the generative AI model 110 for generating descriptions 112 of pages in a page window 108. In one or more embodiments, the indexer 104 may also receive a user-provided description 112 of the one or more contextually relevant pages which may be included in these prompts, thereby providing the generative AI model 110 with additional context as to the nature of the one or more contextually relevant pages.

Although at least one embodiment described above includes an indexer 104 performing various steps, in one or more other embodiments, another entity may perform one or more of the steps described above. For example, a generative AI model may perform one or more of the steps, a different software module may perform one or more of the steps, a dedicated hardware component may perform one or more of the steps, a user may perform one or more of the steps, or some other entity (including combinations thereof) may perform one or more of the steps described above. As such, one or more embodiments are contemplated where another entity performs at least one or the steps described above. Likewise, although one or more embodiments are described where the generative AI model 110 performs one or more of the steps, in another embodiment the indexer 104 may perform one or more of the steps in place of the generative AI model 110.

Although at least one embodiment described above includes an AI model receiving a prompt, in other or more other embodiments, the AI model may receive some other form of input. For example, the AI model (e.g., an LLM) may receive input via one or more API calls, the AI model may receive input that the AI model itself generates, the AI model may receive input from another software module, or the AI model may receive input in some other way. As such, one or more embodiments are contemplated where the AI model receives input from sources other than a prompt.

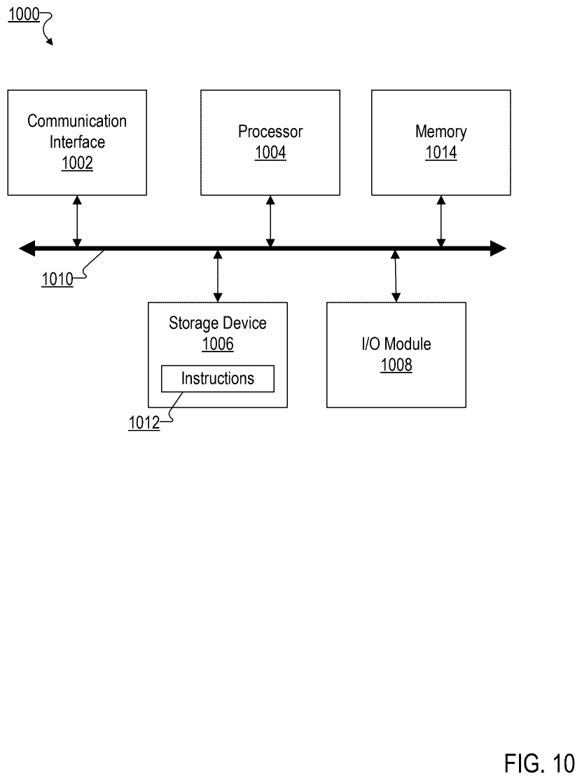

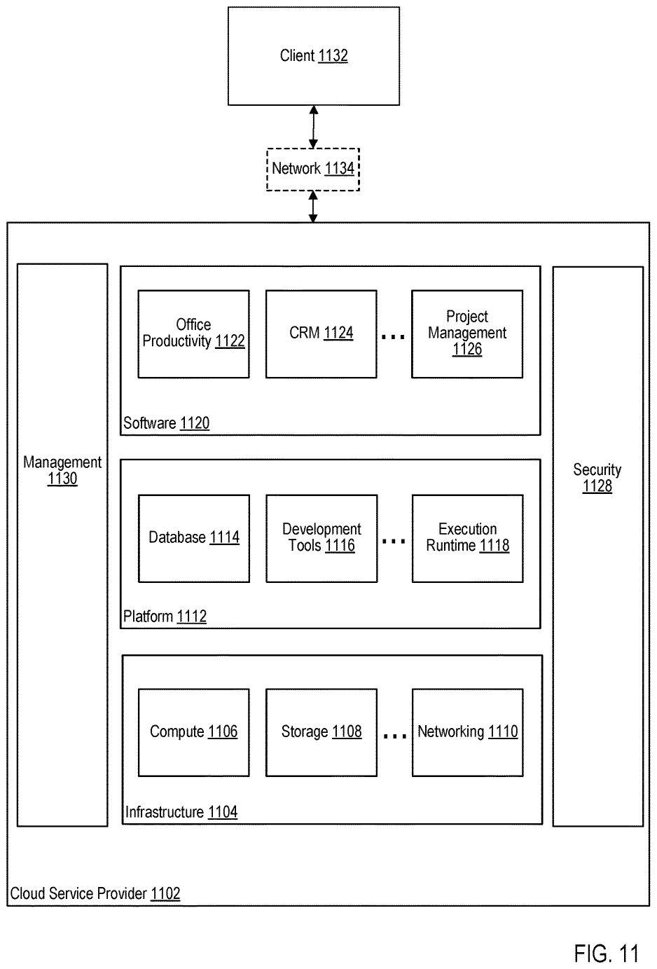

For further explanation, the sections included below provide some details regarding technologies that may be used to support sliding window document indexing using generative AI in accordance with some embodiments. For example, FIG. 10 sets forth an example of a computing device that may be used for some portion of securing an operating system in accordance with some embodiments. As an additional example of technologies that may be used to support sliding window document indexing using generative AI, FIG. 11 sets forth a block diagram of a cloud service provider 1102 service architecture in accordance with some embodiments of the present disclosure.

For further explanation, FIG. 10 illustrates an exemplary computing device 1000 that may be specifically configured to perform one or more of the processes described herein. As shown in FIG. 10, computing device 1000 may include a communication interface 1002, a processor 1004, a storage device 1006, an input/output (I/O) module 1008, and computer memory 1014 communicatively connected one to another via a communication infrastructure 1010. While an exemplary computing device 1000 is shown in FIG. 10, the components illustrated in FIG. 10 are not intended to be limiting. Additional or alternative components may be used in other embodiments. Components of computing device 1000 shown in FIG. 10 will now be described in additional detail.

Communication interface 1002 may be configured to communicate with one or more computing devices. Examples of communication interface 1002 include, without limitation, a wired network interface (such as a network interface card), a wireless network interface (such as a wireless network interface card), a modem, an audio/video connection, and any other suitable interface.

Processor 1004 generally represents any type or form of processing unit capable of processing data and/or interpreting, executing, and/or directing execution of one or more of the instructions, processes, and/or operations described herein. Processor 1004 may perform operations by executing computer-executable instructions 1012 (e.g., an application, software, code, and/or other executable data instance) stored in storage device 1006.

Storage device 1006 may include one or more data storage media, devices, or configurations and may employ any type, form, and combination of data storage media and/or device. For example, storage device 1006 may include, but is not limited to, any combination of non-volatile media and/or volatile media. Electronic data, including data described herein, may be temporarily and/or permanently stored in storage device 1006. For example, data representative of computer-executable instructions 1012 configured to direct processor 1004 to perform any of the operations described herein may be stored within storage device 1006. In some examples, data may be arranged in one or more databases residing within storage device 1006.

I/O module 1008 may include one or more I/O modules configured to receive user input and provide user output. I/O module 1008 may include any hardware, firmware, software, or combination thereof supportive of input and output capabilities. For example, I/O module 1008 may include hardware and/or software for capturing user input, including, but not limited to, a keyboard or keypad, a touchscreen component (e.g., touchscreen display), a receiver (e.g., an RF or infrared receiver), motion sensors, and/or one or more input buttons.

I/O module 1008 may include one or more devices for presenting output to a user, including, but not limited to, a graphics engine, a display (e.g., a display screen), one or more output drivers (e.g., display drivers), one or more audio speakers, and one or more audio drivers. In certain embodiments, I/O module 1008 is configured to provide graphical data to a display for presentation to a user. The graphical data may be representative of one or more graphical user interfaces and/or any other graphical content as may serve a particular implementation. In some examples, any of the systems, computing devices, and/or other components described herein may be implemented by computing device 1000.

For further explanation and as an additional example of a supporting technology for sliding window document indexing using generative AI, FIG. 11 sets forth a block diagram of a cloud service provider service architecture in accordance with some embodiments. The cloud service provider 1102 can deliver a variety of resources through a services-based consumption model where resources are consumed on-demand and as-a-service. Cloud service providers can provide services via cloud platforms such as, for example, Microsoft Azure™M, Amazon Web Services (‘AWS’)™, Google Cloud Platform (‘GCP’)™, and others. In FIG. 11, the cloud service provider 1102 is accessed from a client device 1134 via a network 1132.

FIG. 11 depicts an embodiment where software 1120 is delivered as a service. Software-as-a-service (‘SaaS’) is a model where software applications are delivered over the internet as-a-service. Rather than installing and maintaining software locally, users can access software via a web browser or other network connected interface, eliminating the need for complex software and hardware management on the client-side. In FIG. 11, as examples of software 1120 that can be delivered as-a-service, the illustrated embodiment includes office productivity 1122 software, customer relationship management (‘CRM’) 1124 software, and project management 1126 software. The office productivity 1122 software can include applications designed to facilitate common business and personal tasks, including word processing applications, applications for spreadsheet creation, presentation design applications, and many others. The CRM 1124 software can include applications for managing a business organization's relationships and interactions with customers and potential customers. The project management 1126 software can include applications designed to help teams plan, organize, and manage projects efficiently by facilitating collaboration and tracking the progress of projects. Readers will appreciate that in other embodiments, other types of software may be delivered using a SaaS model.

FIG. 11 depicts an embodiment where platforms 1112 can be delivered as a service. Platform-as-a-service (‘PaaS’) is a model that provides cloud customers with platform resources that they can use to develop, run, and manage applications without the complexity of such deploying and managing such infrastructure on their own. In FIG. 11, as examples of platform 1112 resources that can be delivered as-a-service, the illustrated embodiment includes database 1114 services, development tools 1116 services, and execution runtime 1118 services. The database 1114 services can be used to provide access to databases without management overhead for the user as the cloud service provider manages the provisioning, scaling, and maintenance of the databases. The development tools 1116 services can provide developers with tools to design, develop, test, and deploy applications without needing to manage the underlying infrastructure. The execution runtime 1118 services can provide environments where applications or other forms of computer program code can be executed, including services to scale the execution environment. Readers will appreciate that in other embodiments, other platform resources may be delivered using a PaaS model.

FIG. 11 depicts an embodiment where infrastructure 1104 can be delivered as a service.

Infrastructure-as-a-Service (‘IaaS’) is a model that provides virtualized computing resources over the internet, such that infrastructure such as servers, storage, networks, and others may be leased on demand rather than purchasing and maintaining physical hardware. In FIG. 11, as examples of infrastructure 1104 resources that can be delivered as-a-service, the illustrated embodiment includes compute 1106 services, storage 1108 services, and networking 1110 services. The compute 1106 services can be used to provide on-demand access to computational resources such as VMs, containers, and serverless functions, where the cloud service provider manages the provisioning, scaling, and maintenance of such resources. The storage 1108 services can provide storage resources that can be used to store and access data, without the need for customers to purchase and manage on-premises physical storage resources. The networking 1110 services can provide the ability to create and manage virtualized networking resources such as, for example, virtual private networks (‘VPNs’), firewalls, load balancers, and more. Readers will appreciate that in other embodiments, other infrastructure resources may be delivered using a PaaS model.

The cloud service provider of FIG. 11 also provides management 1130 resources. The management 1130 resources can include, for example, tools and interfaces that enable customers to efficiently deploy, monitor, and manage, their cloud services. Such tools can include web-based management consoles, command-line interfaces (‘CLIs’), APIs, automation tools, and other tools.

The cloud service provider of FIG. 11 also provides security 1128 resources. The security 1128 resources can include, for example, tools and services to help customers protect their cloud environments and ensure compliance with security standards. These tools and services may provide specific aspects of security, including identity and access management, network security, threat detection, compliance management, and others.

Readers will appreciate that many of the components described above may be delivered as services from a cloud service provider. For example, the virtual machines, containers, and pods described above may all be delivered via a cloud service provider. In other embodiments, other forms of compute resources may be used in place of the virtual machines or other compute resource. For example, AWS EC2 instances or other form of cloud compute instances may be utilized in place of the virtual machines.

Advantages and features of the present disclosure can be further described by the following statements:

1. A method of sliding window document indexing using generative artificial intelligence (AI), comprising: generating, for each page window of a plurality of page windows of a document, a description of each page of a respective page window, including: selecting a particular page window of a plurality of page windows of the document by applying a sliding window to a plurality of pages of the document; prompting a generative artificial intelligence (AI) model to generate a description of each page in the particular page window based on any included visual content and contextual information including each other page in the particular page window; and receiving, as output from the generative AI model, the description of each page in the particular page window; and generating index data for the document based on the output from the generative AI model for each page window of the plurality of page windows.

2. The method of claim 1, wherein generating the index data further comprises: providing, for each page of the plurality of pages and to the generative AI model, a plurality of descriptions each corresponding to a different page window including a corresponding page; receiving, for the corresponding page and from the generative AI model, a selection of a particular description of the plurality of descriptions; and generating a portion of the index data for the corresponding page based on the particular description.

3. The method of statements 1 or 2, further comprising identifying, from the document, one or more contextually relevant pages, wherein the one or more contextually relevant pages are included in the contextual information.

4. The method of any combination of one or more of statements 1-3, wherein identifying the one or more contextually relevant pages comprises prompting the generative AI model to identify the one or more contextually relevant pages based on one or more previously generated descriptions of the one or more contextually relevant pages.

5. The method of any combination of one or more of statements 1-4, wherein identifying the one or more contextually relevant pages comprises prompting the generative AI model to identify the one or more contextually relevant pages based on a listing of sections of the document.

6. The method of any combination of one or more of statements 1-5, wherein identifying the one or more contextually relevant pages comprises receiving a user selection of the one or more contextually relevant pages.

7. The method of any combination of one or more of statements 1-6, wherein the generative AI model comprises a language model.

8. An apparatus for sliding window document indexing using generative artificial intelligence (AI), comprising: a memory; and one or more processing devices, operatively coupled to the memory, the one or more processing devices configured to: generate, for each page window of a plurality of page windows of a document, a description of each page of a respective page window, wherein, to generate the description of each page of the respective page window, the one or more processing devices are configured to: select a particular page window of a plurality of page windows of the document by applying a sliding window to a plurality of pages of the document; prompt a generative artificial intelligence (AI) model to generate a description of each page in the particular page window based on any included visual content and contextual information including each other page in the particular page window; and receive, as output from the generative AI model, the description of each page in the particular page window; and generate index data for the document based on the output from the generative AI model for each page window of the plurality of page windows.

9. The apparatus of statement 8, wherein, to generate the index data, the one or more processing devices are further configured to: provide, for each page of the plurality of pages and to the generative AI model, a plurality of descriptions each corresponding to a different page window including a corresponding page; receive, for the corresponding page and from the generative AI model, a selection of a particular description of the plurality of descriptions; and generate a portion of the index data for the corresponding page based on the particular description.

10. The apparatus of statements 8 or 9, wherein the one or more processing devices are further configured to identify, from the document, one or more contextually relevant pages, wherein the one or more contextually relevant pages are included in the contextual information.

11. The apparatus of any combination of one or more of statements 8-10, wherein, to identify the one or more contextually relevant pages, the one or more processing devices are further configured to prompt the generative AI model to identify the one or more contextually relevant pages based on one or more previously generated descriptions of the one or more contextually relevant pages.

12. The apparatus of any combination of one or more of statements 8-11, wherein, to identify the one or more contextually relevant pages, the one or more processing devices are further configured to prompt the generative AI model to identify the one or more contextually relevant pages based on a listing of sections of the document.

13. The apparatus of any combination of one or more of statements 8-12, wherein, to identify the one or more contextually relevant pages, the one or more processing devices are further configured to receive a user selection of the one or more contextually relevant pages.

14. The apparatus of any combination of one or more of statements 8-13, wherein the generative AI model comprises a language model.

15. A non-transitory computer readable storage medium storing instructions which, when executed, cause a processing device to: generate, for each page window of a plurality of page windows of a document, a description of each page of a respective page window, wherein, to generate the description of each page of the respective page window, the instructions, when executed, cause the processing device to: select a particular page window of a plurality of page windows of the document by applying a sliding window to a plurality of pages of the document; prompt a generative artificial intelligence (AI) model to generate a description of each page in the particular page window based on any included visual content and contextual information including each other page in the particular page window; and receive, as output from the generative AI model, the description of each page in the particular page window; and generate index data for the document based on the output from the generative AI model for each page window of the plurality of page windows.

16. The non-transitory computer readable storage medium of statement 15, wherein, to generate the index data, the instructions, when executed, cause the processing device to: provide, for each page of the plurality of pages and to the generative AI model, a plurality of descriptions each corresponding to a different page window including a corresponding page; receive, for the corresponding page and from the generative AI model, a selection of a particular description of the plurality of descriptions; and generate a portion of the index data for the corresponding page based on the particular description.

17. The non-transitory computer readable storage medium of statements 15 or 16, wherein the instructions, when executed, cause the processing device to identify, from the document, one or more contextually relevant pages, wherein the one or more contextually relevant pages are included in the contextual information.

18. The non-transitory computer readable storage medium of any combination of one or more of statements 15-17, wherein, to identify the one or more contextually relevant pages, the instructions, when executed, cause the processing device to prompt the generative AI model to identify the one or more contextually relevant pages based on one or more previously generated descriptions of the one or more contextually relevant pages.

19. The non-transitory computer readable storage medium of any combination of one or more of statements 15-18, wherein, to identify the one or more contextually relevant pages, the instructions, when executed, cause the processing device to prompt the generative AI model to identify the one or more contextually relevant pages based on a listing of sections of the document.

20. The non-transitory computer readable storage medium of any combination of one or more of statements 15-19, wherein, to identify the one or more contextually relevant pages, the instructions, when executed, cause the processing device to receive a user selection of the one or more contextually relevant pages.

Although some embodiments are described largely in the context of a system, method, or in some other way, readers will recognize that embodiments of the present disclosure may also take the form of a computer program product disposed upon computer readable storage media for use with any suitable processing system. Such computer readable storage media may be any storage medium for machine-readable information, including magnetic media, optical media, solid-state media, or other suitable media. Examples of such media include magnetic disks in hard drives or diskettes, compact disks for optical drives, magnetic tape, and others as will occur to those of skill in the art. Persons skilled in the art will immediately recognize that any computer system having suitable programming means will be capable of executing the steps described herein as embodied in a computer program product. Persons skilled in the art will recognize also that, although some of the embodiments described in this specification are oriented to software installed and executing on computer hardware, nevertheless, alternative embodiments implemented as firmware or as hardware are well within the scope of the present disclosure.

Readers will appreciate that some embodiments are described in which computer program instructions are executed on computer hardware such as, for example, one or more computer processors. Readers will appreciate that in other embodiments, computer program instructions may be executed on virtualized computer hardware (e.g., one or more virtual machines), in one or more containers, in one or more cloud computing instances (e.g., one or more AWS EC2 instances), in one or more serverless compute instances offered such as those offered by a cloud services provider, in one or more event-driven compute services such as those offered by a cloud services provider, or in some other execution environment.

In some examples, a non-transitory computer-readable medium storing computer-readable instructions may be provided in accordance with the principles described herein. The instructions, when executed by a processor of a computing device, may direct the processor and/or computing device to perform one or more operations, including one or more of the operations described herein. Such instructions may be stored and/or transmitted using any of a variety of known computer-readable media.

A non-transitory computer-readable medium as referred to herein may include any non-transitory storage medium that participates in providing data (e.g., instructions) that may be read and/or executed by a computing device (e.g., by a processor of a computing device). For example, a non-transitory computer-readable medium may include, but is not limited to, any combination of non-volatile storage media and/or volatile storage media. Exemplary non-volatile storage media include, but are not limited to, read-only memory, flash memory, a solid-state drive, a magnetic storage device (e.g., a hard disk, a floppy disk, magnetic tape, etc.), ferroelectric random-access memory (“RAM”), and an optical disc (e.g., a compact disc, a digital video disc, a Blu-ray disc, etc.). Exemplary volatile storage media include, but are not limited to, RAM (e.g., dynamic RAM).

One or more embodiments may be described herein with the aid of method steps illustrating the performance of specified functions and relationships thereof. The boundaries and sequence of these functional building blocks and method steps have been arbitrarily defined herein for convenience of description. Alternate boundaries and sequences can be defined so long as the specified functions and relationships are appropriately performed. Any such alternate boundaries or sequences are thus within the scope and spirit of the claims. Further, the boundaries of these functional building blocks have been arbitrarily defined for convenience of description. Alternate boundaries could be defined as long as the certain significant functions are appropriately performed. Similarly, flow diagram blocks may also have been arbitrarily defined herein to illustrate certain significant functionality.

To the extent used, the flow diagram block boundaries and sequence could have been defined otherwise and still perform the certain significant functionality. Such alternate definitions of both functional building blocks and flow diagram blocks and sequences are thus within the scope and spirit of the claims. One of average skill in the art will also recognize that the functional building blocks, and other illustrative blocks, modules and components herein, can be implemented as illustrated or by discrete components, application specific integrated circuits, processors executing appropriate software and the like or any combination thereof.

While particular combinations of various functions and features of the one or more embodiments are expressly described herein, other combinations of these features and functions are likewise possible. The present disclosure is not limited by the particular examples disclosed herein and expressly incorporates these other combinations.

1. A method of sliding window document indexing using generative artificial intelligence (AI), comprising:
identifying a plurality of page windows of a document, wherein each page window of the plurality of page windows comprises a plurality of pages and wherein at least one page of the plurality of pages of each page window overlaps with at least one page of another page window of the plurality of page windows, and wherein a size of the document exceeds an input limit of a generative artificial intelligence (AI) model;
generating, for each page window of the plurality of page windows of the document, a description of each page of a respective page window, including:
applying a sliding window to a plurality of pages of the document by iterating over the plurality of page windows of the document;
selecting a particular page window of the plurality of page windows of the document by applying a sliding window to a plurality of pages of the document;
prompting the generative AI model to generate a description of each page in the particular page window based on any included visual content and contextual information including each other page in the particular page window; and
receiving, as output from the generative AI model, the description of each page in the particular page window; and
generating index data for the document based on the output from the generative AI model for each page window of the plurality of page windows.

2. The method of claim 1, wherein generating the index data further comprises:
providing, for each page of the plurality of pages and to the generative AI model, a plurality of descriptions each corresponding to a different page window including a corresponding page;
receiving, for the corresponding page and from the generative AI model, a selection of a particular description of the plurality of descriptions; and
generating a portion of the index data for the corresponding page based on the particular description.

3. The method of claim 1, further comprising identifying, from the document, one or more contextually relevant pages, wherein the one or more contextually relevant pages are included in the contextual information.

4. The method of claim 3, wherein identifying the one or more contextually relevant pages comprises prompting the generative AI model to identify the one or more contextually relevant pages based on one or more previously generated descriptions of the one or more contextually relevant pages.

5. The method of claim 3, wherein identifying the one or more contextually relevant pages comprises prompting the generative AI model to identify the one or more contextually relevant pages based on a listing of sections of the document.

6. The method of claim 3, wherein identifying the one or more contextually relevant pages comprises receiving a user selection of the one or more contextually relevant pages.

7. The method of claim 1, wherein the generative AI model comprises a language model.

8. An apparatus for sliding window document indexing using generative artificial intelligence (AI), comprising:
a memory; and
one or more processing devices, operatively coupled to the memory, the one or more processing devices configured to:
identify a plurality of page windows of a document, wherein each page window of the plurality of page windows comprises a plurality of pages and wherein at least one page of the plurality of pages of each page window overlaps with at least one page of another page window of the plurality of page windows, and wherein a size of the document exceeds an input limit of a generative artificial intelligence (AI) model;
generate, for each page window of the plurality of page windows of the document, a description of each page of a respective page window, wherein, to generate the description of each page of the respective page window, the one or more processing devices are configured to:
apply a sliding window to a plurality of pages of the document by iterating over the plurality of page windows of the document;
select a particular page window of the plurality of page windows of the document by applying a sliding window to a plurality of pages of the document;
prompt the generative AI model to generate a description of each page in the particular page window based on any included visual content and contextual information including each other page in the particular page window; and
receive, as output from the generative AI model, the description of each page in the particular page window; and
generate index data for the document based on the output from the generative AI model for each page window of the plurality of page windows.

9. The apparatus of claim 8, wherein, to generate the index data, the one or more processing devices are further configured to:
provide, for each page of the plurality of pages and to the generative AI model, a plurality of descriptions each corresponding to a different page window including a corresponding page;
receive, for the corresponding page and from the generative AI model, a selection of a particular description of the plurality of descriptions; and
generate a portion of the index data for the corresponding page based on the particular description.

10. The apparatus of claim 8, wherein the one or more processing devices are further configured to identify, from the document, one or more contextually relevant pages, wherein the one or more contextually relevant pages are included in the contextual information.

11. The apparatus of claim 10, wherein, to identify the one or more contextually relevant pages, the one or more processing devices are further configured to prompt the generative AI model to identify the one or more contextually relevant pages based on one or more previously generated descriptions of the one or more contextually relevant pages.

12. The apparatus of claim 10, wherein, to identify the one or more contextually relevant pages, the one or more processing devices are further configured to prompt the generative AI model to identify the one or more contextually relevant pages based on a listing of sections of the document.

13. The apparatus of claim 10, wherein, to identify the one or more contextually relevant pages, the one or more processing devices are further configured to receive a user selection of the one or more contextually relevant pages.

14. The apparatus of claim 8, wherein the generative AI model comprises a language model.

15. A non-transitory computer readable storage medium storing instructions which, when executed, cause a processing device to:
identify a plurality of page windows of a document, wherein each page window of the plurality of page windows comprises a plurality of pages and wherein at least one page of the plurality of pages of each page window overlaps with at least one page of another page window of the plurality of page windows, and wherein a size of the document exceeds an input limit of a generative artificial intelligence (AI) model;
generate, for each page window of the plurality of page windows of the document, a description of each page of a respective page window, wherein, to generate the description of each page of the respective page window, the instructions, when executed, cause the processing device to:
apply a sliding window to a plurality of pages of the document by iterating over the plurality of page windows of the document;
select a particular page window of the plurality of page windows of the document by applying a sliding window to a plurality of pages of the document;
prompt the generative AI model to generate a description of each page in the particular page window based on any included visual content and contextual information including each other page in the particular page window; and
receive, as output from the generative AI model, the description of each page in the particular page window; and
generate index data for the document based on the output from the generative AI model for each page window of the plurality of page windows.

16. The non-transitory computer readable storage medium of claim 15, wherein, to generate the index data, the instructions, when executed, cause the processing device to:
provide, for each page of the plurality of pages and to the generative AI model, a plurality of descriptions each corresponding to a different page window including a corresponding page;
receive, for the corresponding page and from the generative AI model, a selection of a particular description of the plurality of descriptions; and
generate a portion of the index data for the corresponding page based on the particular description.

17. The non-transitory computer readable storage medium of claim 15, wherein the instructions, when executed, cause the processing device to identify, from the document, one or more contextually relevant pages, wherein the one or more contextually relevant pages are included in the contextual information.

18. The non-transitory computer readable storage medium of claim 17, wherein, to identify the one or more contextually relevant pages, the instructions, when executed, cause the processing device to prompt the generative AI model to identify the one or more contextually relevant pages based on one or more previously generated descriptions of the one or more contextually relevant pages.

19. The non-transitory computer readable storage medium of claim 17, wherein, to identify the one or more contextually relevant pages, the instructions, when executed, cause the processing device to prompt the generative AI model to identify the one or more contextually relevant pages based on a listing of sections of the document.

20. The non-transitory computer readable storage medium of claim 17, wherein, to identify the one or more contextually relevant pages, the instructions, when executed, cause the processing device to receive a user selection of the one or more contextually relevant pages.
